(19) United States
(12) Patent Application Publication
(10) Pub. No.: US 2006/0082179 A1
(43) Pub. Date: Apr. 20, 2006

(54) AUTOMOTIVE TRIM ASSEMBLY HAVING IMPACT COUNTERMEASURES AND METHOD OF MAKING THE SAME

(76) Inventors: Todd L DePue, Brighton, MI (US); Michael J Hier, Milford, MI (US); Glenn A Cowelchuk, Chesterfield Township, MI (US); David Dooley, Troy, MI (US); Randy S Reed, Fair Haven, MI (US)

Correspondence Address: WOOD, HERRON & EVANS, LLP (LEAR), 2700 CAREW TOWER, 441 VINE STREET, CINCINNATI, OH, 45202, US

(21) Appl. No.: 10/904,015

(22) Filed: Oct. 19, 2004

(51) Int. Cl. B60R 13/02

(52) U.S. Cl. 296/39.1

(57) ABSTRACT

An automotive trim assembly including a substrate made from a first material and having a front surface adapted to face the interior of the automobile and a back surface opposite the front surface. A cover member made from a second foamed material is molded onto at least a portion of the front surface of the substrate so as to provide a soft feel to the trim assembly. An impact countermeasure, also made from the second foamed material, is molded onto at least a portion of the back surface to absorb an impact force from a vehicle occupant. The trim assembly may be made in a two shot molding operation with the substrate being formed in the first shot of the molding process and the cover member and countermeasure being formed in the second shot of the molding process.

### FIELD OF THE INVENTION

The present invention pertains generally to automotive interior trim assemblies and more particularly to countermeasure structures used to reduce the force of impact on a vehicle occupant.

### BACKGROUND OF THE INVENTION

It is known to provide automotive interiors with various active and passive occupant protection systems. An example of an active occupant protection system is the well-known inflatable airbag that is deployed upon impact. The airbag, however, does not completely protect the occupant, as there are other areas of contact in the vehicle, including the roof structure, door structures, knee bolster panels, and the pillars that support the roof. Automotive interiors often provide passive protection systems in these areas. Indeed, such protection measures are the subject of regulations and associated legislation so far as vehicle manufactures are concerned. In particular, the U.S. Federal Motor Vehicle Safety Standard 201 defines particular impact characteristics and requirements for automotive interiors.

By way of example, an automotive pillar is a structural member provided to support the roof of the vehicle. For instance, as is known in the automotive industry, the A-pillar supports the roof toward the front of the passenger cabin and is typically located between the front windshield and the front door. Likewise, the B-pillar supports the roof toward the middle of the passenger cabin and is typically located between the front and rear doors. The C-pillar supports the roof toward the rear of the passenger cabin behind the rear door. For larger vehicles, additional pillars may be used to support the roof structure of the vehicle. An interior trim assembly typically covers the pillar(s) and is required to fulfill several functions. For instance, the trim assembly needs to present an aesthetically pleasing surface finish to the interior of the vehicle. The trim assembly also needs to provide a convenient means of routing and attaching components in the vehicle interior. The trim assembly further needs to provide a degree of acoustical damping in order to reduce the noise in the vehicle.

Because the pillars are in close proximity to heads of persons traveling in the vehicle, the pillar trim assemblies are also now required to provide some level of energy management, arising from a requirement to absorb energy upon impact by a vehicle occupant's body. Providing energy management capabilities to the trim assembly applies to not only pillar trim assemblies, but also to other trim assemblies, including door and roof trim assemblies and other body contacting trim assemblies.

Automotive trim assemblies, such as pillar trim assemblies, may be constructed in a variety of ways and typically include a relatively rigid substrate having a front surface facing the interior of the vehicle and a back surface opposite the front surface adapted to face and couple to a vehicle support member, such as a pillar. The rigid substrate provides structural support for the trim assembly and defines the general shape of the trim assembly. Many trim assemblies further include a cover member of leather, cloth, vinyl, or the like disposed over the front surface of the substrate to provide a soft touch and an aesthetically pleasing appearance to the interior of the vehicle.

The conventional approach to incorporate energy management foam into currently designed trim assemblies is to attach individual foam pads to selective locations on the back surface of the trim assembly. The foam pads are typically made and packaged in one location and shipped to the manufacturer of the trim assemblies. The foam pads are then manually attached to the back surface of the trim assembly using, for example, hand-held dispensing guns dispensing a hot melt adhesive. This conventional approach to making trim assemblies having energy management capabilities is labor intensive, time consuming, and requires multiple parts and multiple operational steps, which translates into higher manufacturing costs for the various automotive trim assemblies.

There is a need for an improved interior trim assembly and a method for incorporating foam-based countermeasures that reduce the labor and overall manufacturing costs.

### SUMMARY OF THE INVENTION

The present invention provides an automotive trim assembly that incorporates a foam impact countermeasure, but which can be produced in an efficient and cost-effective manner. In one embodiment, the trim assembly comprises a substrate made from a first material and having a front surface adapted to face an automotive interior and a back surface opposite to the front surface. A cover member made from a second foamed material is molded onto at least a portion of the front surface of the substrate so as to provide a soft touch or feel to the trim assembly. An impact countermeasure also made from the second foamed material is molded onto at least a portion of the back surface of the substrate and adapted to absorb an impact force from a vehicle occupant during, for example, a collision. The countermeasure may include at least one rib, and preferably two ribs, extending along the length of the trim assembly.

In an exemplary embodiment, the substrate has a first hardness and the cover member and countermeasure have a second hardness that is relatively lower than the first hardness. For example, the substrate may be formed from a variety of thermoplastic polymers, such as a thermoplastic olefin or polypropylene. The cover member and countermeasure may be formed from a foamed thermoplastic polymer, such as a foamed thermoplastic elastomer or foamed thermoplastic olefin. In this way, the substrate provides sufficient structure to the trim assembly, the cover member provides an attractive surface having a soft feel, and the countermeasure provides an energy absorbing capability.

The trim assembly may advantageously be formed from a two-shot molding operation. A first curable material is injected into a mold during a first shot of the molding process to form the substrate. A second curable foamed material is then injected into the mold during a second shot of the molding operation to form the cover member and the countermeasure. The substrate may include at least one aperture therethrough so that during the second shot of the molding operation, the second foamed material fills the aperture so that the cover member and countermeasure form a unitary structure.

The features and objectives of the present invention will become more readily apparent from the following Detailed Description taken in conjunction with the accompanying drawings.

### BRIEF DESCRIPTION OF THE DRAWINGS

The accompanying drawings, which are incorporated in and constitute a part of this specification, illustrate embodiments of the invention and, together with a general description of the invention given above, and the detailed description given below, serve to explain the invention.

FIG. 1 is a perspective view of an exemplary automotive interior including a pillar trim panel according to the present invention;

FIG. 2 is a cross-sectional view of the pillar trim assembly of FIG. 1;

FIG. 3 is a perspective view of a mold assembly for making the pillar trim panel of FIG. 1;

FIG. 4 is a cross-sectional view of the mold assembly of FIG. 3 illustrating the first shot of the molding operation; and

FIG. 5 is a cross-sectional view of the mold assembly of FIG. 3 illustrating the second shot of the molding operation.

### DETAILED DESCRIPTION

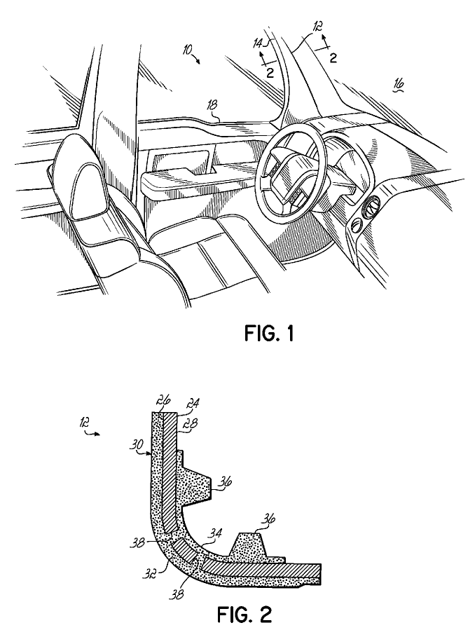

Referring to FIG. 1, there is shown a portion of an automobile 10 having a number of exemplary trim assemblies, such as pillar trim panel 12, that cover the interior of the automobile to provide an aesthetically pleasing environment, to reduce noise levels inside the vehicle, and to absorb energy in the event of a collision. The various trim assemblies lining the interior of the automobile are generally constructed in a similar fashion. Thus, although the following detailed description will be directed toward a trim assembly for an automotive pillar, such as pillar trim panel 12, those having ordinary skill in the art will recognize that the invention may equally apply to other trim assemblies in the automobile, such as door panels, instrument panels, roof panels, knee bolster panels, and other body contacting trim assemblies.

As shown in FIGS. 1 and 2, pillar trim panel 12 is installed in the forward portion of the passenger cabin to cover what are known in the automotive industry as the A-pillars 14, which separate the windshield 16 from the side doors 18. Pillars are generally support structures that extend between the automotive body and the roof (not shown) to provide support thereto. Automobile 10 may include multiple pairs of pillars (B-pillars, C-pillars, etc.) to which the invention equally applies.

The pillar trim panel 12 includes a relatively rigid substrate 24, which forms at least a portion of the structural support of the trim assembly, and defines the general shape of pillar trim panel 12. The substrate 24 is then secured to the interior side of pillar 14, for example, by a bracket or mounting member (not shown) to position the trim panel 12 within the passenger cabin. Substrate 24 includes a front surface 26 that faces the interior of the automobile 10 and a back surface 28 opposite the front surface 26 that is hidden from view when pillar trim panel 12 is mounted to the automobile 10. Substrate 24 may be made from a first material having a first hardness that may include a thermoplastic polymer, such as a thermoplastic olefin or polypropylene. As recognized by those of ordinary skill in the art, the substrate 24 may include one or more collapsible ribs (not shown) integrally formed with substrate 24. The collapsible ribs provide an additional energy absorbing capacity.

In one embodiment, the pillar trim assembly 12 further includes an integrally formed trim element, generally shown at 30, that is molded onto at least a portion of substrate 24. The trim element 30 defines a cover member 32 molded onto at least a portion of the front surface 26 of the substrate 24 and an impact countermeasure 34 molded onto at least a portion of the back surface 28 of the substrate 24. The cover member 32 is adapted to provide an aesthetically pleasing appearance to pillar trim panel 12 and to provide a soft touch or feel to enhance the comfort of the vehicle occupants. The countermeasure 34 is adapted to absorb an impact force from a vehicle occupant in the event of a collision. The pillar trim panel 12 has a length and the countermeasure 34 is configured as a rib, and preferably a pair of ribs 36, that project from the back surface 28 of the substrate 24 and extend along at least a portion of the length of the pillar trim panel 12. As recognized by those of ordinary skill in the art, the countermeasure 34 may have other configurations with multiple energy absorbing structures. As further recognized by those of ordinary skill in the art, the countermeasure 34 may be molded over the molded with the collapsible ribs formed in substrate 24.

Advantageously, the trim element 30 comprising the cover member 32 and countermeasure 34 may be formed from a single material. In particular, the trim element 30 may be formed from a second foamed material having a second hardness that is relatively lower than the first hardness of substrate 24. The second foamed material may include a foamed thermoplastic polymer, such as a foamed thermoplastic elastomer or a foamed thermoplastic olefin. The second foamed material produces an outer skin and a light, cellular inner core that collectively provides the soft touch to the front surface 26 of the substrate 24 and the energy absorbing capability to the countermeasure 34 on the back surface 28 of substrate 24. The second material may be foamed, or activated, by a blowing agent, such as sodium bicarbonate, nitrogen, or any other commonly known agent as is known in the art. The cover member 32 and countermeasure 34 may be coupled to form the integral trim element 30. To this end, the substrate 24 may include at least one aperture 38 (2 shown) formed therethrough that is adapted to be filled with the second foamed material during the manufacturing process so that the trim element 30 has the integral structure.

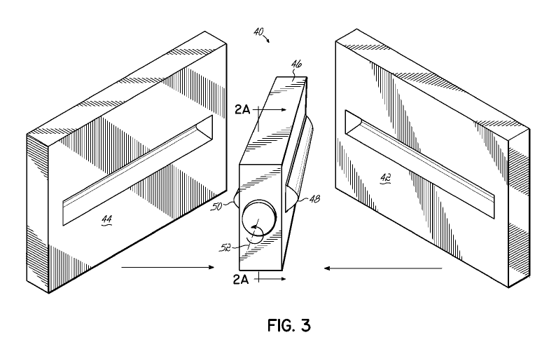

With reference to FIGS. 3-5, a method of making the automotive interior trim assembly having a cover member 32 and impact countermeasure 34 will now be described. A single mold assembly 40 is shown in FIG. 3 including spaced apart first and second shot mold cavities 42 and 44, respectively, and a central core 46 having first and second male portions 48 and 50, respectively, adapted to mate with each cavity 42, 44. The core 46 is situated between the mold cavities 42, 44 and is adapted to rotate about a central axis, i.e. a horizontal axis 52, so that the first and second male portions 48, 50 can mate, in turn, with the mold cavities 42, 44 to mold, in sequence, first the substrate 24 then the cover member 32 and impact countermeasure 34. It should be understood by those of ordinary skill in the art that variations of the mold assembly 40 may be provided and still fall within the scope of this invention. For example, any number of core male portions 48, 50 (i.e., more or less than shown) may be provided, in conjunction with the necessary number or corresponding first and second shot mold cavities 42, 44, for molding the substrate 24 having a cover member 32 that provides a soft feel and an impact countermeasure 34 for absorbing an impact force from a vehicle occupant.

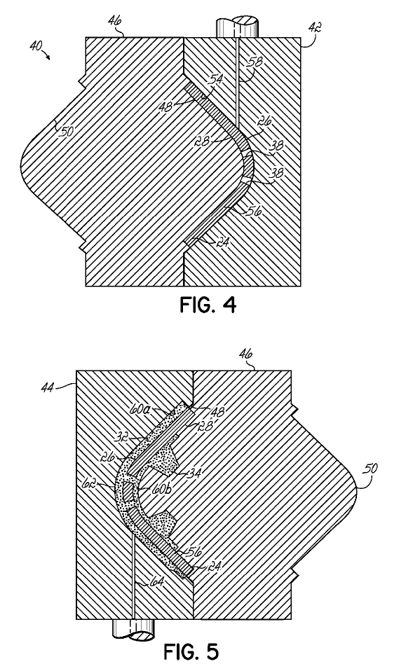

While the first and second shots of the molding operation are further described below with respect to the first male portion 48 by utilizing the cross-sectional views of FIGS. 4 and 5, it is understood that the first and second shot molding process occurs in the same fashion with respect to the second male portion 50. Accordingly, as best shown in FIGS. 3 and 4, the first male portion 48 of the core 46 mates with first shot mold cavity 42 and, more specifically, the first shot mold cavity 42 is adapted to move toward the first male portion 48, as is commonly known in the art, to form a first shot chamber 54. In a first shot of the molding operation, a first curable material 56, which may be a thermoplastic polymer such as thermoplastic olefin, polypropylene, or other suitable materials is injected through a channel 58 into the first shot chamber 54 to form the substrate 24. Specifically, the molded substrate 24 is molded over the first male portion 48 such that the first male portion 48 retains the substrate 24. A moveable slide (not shown), as known in the art, may be provided within the first shot mold cavity 42 to produce the apertures 38 formed through substrate 24.

With reference to FIGS. 3 and 5, the first shot mold cavity 42 is retracted, or moved away from the first male portion 48, and the core 46 having the first male portion 48 provided with the substrate 24 is then rotated about the horizontal axis 52 to move the substrate 24 from the first shot mold cavity 42 to the second shot mold cavity 44. Next, the first male portion 48 of the core 46 mates with the second shot mold cavity 44 and, more specifically, the second shot mold cavity 44 is adapted to move toward the first male portion 48, as is commonly known in the art, to form a portion of a second shot chamber 60a about at least a portion of the front surface 26 of the substrate 24. The portion of second shot chamber 60a is adapted to form the cover member 32 on the front surface 26 of substrate 24. A moveable slide (not shown) is further provided with core 46 and retracted to form another portion of second shot chamber 60b about at least a portion of the back surface 28 of the substrate 24. The other portion of second mold chamber 60b is adapted to form the impact countermeasure 34 on the back surface 28 of substrate 24.

In a second shot of the molding operation, the second curable foamed material 62, which may be a foamed thermoplastic polymer such as foamed thermoplastic elastomer or foamed thermoplastic olefin having an additive blowing agent mixed therein, is injected through a channel 64 into the second shot mold chamber 60a, 60b to form the cover member 32 and impact countermeasure 34. The second foamed material 62 flows into second shot mold chamber 60a then through the apertures 38 formed in substrate 24 and into second shot mold chamber 60b. In this way, only one channel must be provided in the second shot mold cavity 44 so as to form both the cover member 32 and impact countermeasure 34 on opposite sides of the substrate 24. This allows the cover member 32 and impact countermeasure 34 to be formed as an integral trim element 30. Notably, the cover member 32 and impact countermeasure 34 are bonded, or integrally molded, to at least portions of the front and back surfaces 26, 28, respectively, of the substrate 24 to provide a soft feel and impact absorbing capabilities.

The second foamed material 62 is activated, or foamed, by introducing a physical or chemical blowing agent into the molten polymer, generally prior to being injected into the second shot mold chamber 60a, 60b. Generally, the blowing agent works by expanding the polymer to produce a cellular structure having significantly less density than the polymer itself. The blowing agent may be any chemical agent that liberates gas when heated above a characteristic decomposition temperature (e.g. sodium bicarbonate that liberates CO₂ when heated above its decomposition temperature), any physical agent such as any gas (e.g. gaseous nitrogen), or any other known blowing agent. As the polymer cools and hardens, gas-filled bubbles originating from the blowing agent define the foamed structure of a given density. Depending upon the molding conditions, the cell structure of the cured polymer may either be closed or open. The soft feel of the cover member 32 may be adjusted to any desired softness by varying the thickness of the cover member. Likewise, the amount of energy absorbed by the countermeasure 34 may be adjusted by altering the thickness of the countermeasure 34.

After the second foamed material 62 has been allowed sufficient time to cure, the second shot mold cavity 44 is retracted, or moved away from, the first male portion 48, and the automotive interior trim assembly, i.e., the pillar trim panel 12, is ejected from the first male portion 48, such as by ejector pins (not shown), so that the process may begin anew. Although not illustrated, it is understood that the second male portion 50 also is adapted to mate with first shot cavity 42, during the mating of the first male portion 48 with the second shot mold cavity 44, to form a second substrate (not shown) identical to the first substrate 24 by injecting the first material 56 into the first shot mold chamber 54 in the first shot of the molding operation. After injection, the core 46 with the second male portion 50 similarly rotates the second substrate to the second shot mold cavity 44 for the second shot of the molding operation while the first male portion 48 return to the first shot mold cavity 42 to repeat the first shot of the molding operation. In this way, a plurality of automotive interior trim assemblies may be formed in a continuous and efficient manner.

With further reference to FIG. 1, the pillar trim assembly 12 includes the substrate 12 with an integrally formed trim element 30 molded thereto. The trim element 30 defines a cover member 32 molded to the front surface 26 of the substrate 24 and impact countermeasure 34 molded to the back surface 28 of the substrate 24. The trim panel 12 may now be coupled, by means known in the art, to a pillar 14 of the automobile 10. Accordingly, the molding operation of the present invention may be continuously performed utilizing a single mold assembly 40 to provide an improved pillar trim assembly 12 having a soft touch cover member 32 and energy absorbing countermeasure 34.

Although the method of making the trim assembly utilizes a single mold assembly for a continuous, integrated process, it should be understood that the molding process may be performed in more than one mold assembly such that the trim panel may be moved from the first shot mold cavity after the first shot to a second shot mold cavity provided in a second, separate mold assembly for the second shot of the molding operation. Movement can be done manually or by other means commonly known in the art, e.g. robotically.

While the present invention has been illustrated by the description of the various embodiments thereof, and while the embodiments have been described in considerable detail, it is not intended to restrict or in any way limit the scope of the appended claims to such detail. Additional advantages and modifications will readily appear to those skilled in the art. The invention in its broader aspects is therefore not limited to the specific details, representative apparatus and methods and illustrative examples shown and described. Accordingly, departures may be made from such details without departing from the scope or spirit of Applicant's general inventive concept.

What is claimed is:

1. An automotive interior trim assembly, comprising:
a substrate made from a first material and having a front surface adapted to face an automotive interior and a back surface opposite to said front surface;
a cover member made from a second foamed material molded onto at least a portion of said front surface and adapted to provide a soft feel to the trim assembly; and
an impact countermeasure made from the second foamed material molded onto at least a portion of said back surface and adapted to absorb an impact force from a vehicle occupant in the event of a collision.

2. The trim assembly of claim 1, wherein said substrate has a first hardness and said cover member and said countermeasure have a second hardness less than the first hardness.

3. The trim assembly of claim 1, wherein said substrate has a length, said countermeasure includes a rib extending along at least a portion of said length.

4. The trim assembly of claim 1, wherein said substrate includes at least one aperture formed therethrough, said aperture being filled by the second foamed material to couple said cover member and said countermeasure to form an integral structure made from the second foamed material.

5. The trim assembly of claim 1, wherein said substrate is made from a thermoplastic polymer and said cover member and said countermeasure are made from a foamed thermoplastic polymer.

6. The trim assembly of claim 5, wherein said substrate is made from a material selected from the group consisting of a thermoplastic olefin and polypropylene.

7. The trim assembly of claim 5, wherein said cover member and said countermeasure are made from a material selected from the group consisting of a foamed thermoplastic elastomer and a foamed thermoplastic olefin.

8. The trim assembly of claim 1, wherein said substrate is made from polypropylene and said cover member and said countermeasure are made from a foamed thermoplastic elastomer.

9. The trim assembly of claim 1 in the form of an automotive pillar trim panel.

10. An automotive interior trim assembly, comprising:
a substrate made from a first material and having a first hardness, said substrate having a front surface adapted to face an automotive interior and a back surface opposite to said front surface;
an integrally formed trim element made from a second foamed material and having a second hardness less than the first hardness, said trim element molded onto at least a portion of said substrate and defining a cover member overlying said front surface to provide a soft feel to the trim assembly and an impact countermeasure adapted to absorb an impact force from a vehicle occupant in the event of a collision.

11. The trim assembly of claim 10, wherein said substrate includes at least one aperture formed therethrough, said aperture being filled by the second foamed material to couple said cover member and said countermeasure to form said integral trim element.

12. The trim assembly of claim 10, wherein said countermeasure is molded onto said back surface of said substrate.

13. A method of making an automotive trim assembly in a two-shot molding operation, comprising:
molding a substrate by injecting a first curable material in a first shot of the molding operation;
forming a mold chamber about a portion of the substrate; and
molding a cover member and an impact countermeasure onto the substrate by injecting a second curable foamed material during a second shot of the molding operation.

14. The method of claim 13, wherein injecting the first and second curable materials comprises:
injecting the first curable material having a first hardness; and
injecting the second curable foamed material having a second hardness that is lower than the first hardness.

15. The method of claim 13, wherein the first curable material further comprises a thermoplastic polymer and the second curable foamed material further comprises a foamed thermoplastic polymer.

16. The method of claim 15, wherein the first curable material is selected from the group consisting of a thermoplastic olefin and polypropylene.

17. The method of claim 15, wherein the second curable foamed material is selected from the group consisting of a foamed thermoplastic elastomer and a foamed thermoplastic olefin.

18. The method of claim 13, wherein the first curable material is polypropylene and the second curable foamed material is a foamed thermoplastic elastomer.
